(19) United States
(12) Patent Application Publication
(10) Pub. No.: US 2022/0306889 A1
(43) Pub. Date: Sep. 29, 2022

(54) Home Care Compositions

(71) Applicant: Colgate-Palmolive Company, New York, NY (US)

(72) Inventors: Aida Ninfa SALINAS LOPEZ, Miguel Hidalgo (MX); Cesar RODRIGUEZ CEDILLO, Naucalpan de Juarez (MX); Kristina FABIJANIC, Jersey City, NJ (US); Henry PENA, Edo México (MX); Long PAN, Somerset, NJ (US); Michael STRANICK, Bridgewater, NJ (US)

(73) Assignee: Colgate-Palmolive Company, New York, NY (US)

(21) Appl. No.: 17/641,550

(22) PCT Filed: Aug. 31, 2020
(86) PCT No.: PCT/US2020/048717

§ 371 Date: Mar. 9, 2022

Related U.S. Application Data
(60) Provisional application No. 62/900,900, filed on Sep. 16, 2019.

(51) Int. Cl. C09D 15/00; C09D 7/45; C09D 7/63; C09D 105/00; B05D 7/08; B27K 5/02

(52) U.S. Cl. CPC C09D 15/00; C09D 7/45; C09D 7/63; C09D 105/00; B05D 7/08; B27K 5/02; B27K 2240/90

(57) ABSTRACT

Described herein are home care compositions comprising an alcohol alkoxylate surfactant and a polysaccharide gum, along with methods of making and using same.

### CROSS-REFERENCE TO RELATED APPLICATION

This application claims the benefit of priority from U.S. Provisional Application No. 62/900,900, filed Sep. 16, 2019, the contents of which are hereby incorporated herein by reference in their entirety.

### BACKGROUND

A neutral floor cleaner comprising an alcohol alkoxylate is disclosed in U.S. Pat. No. 9,512,384. That reference discloses compositions and methods for improved cleaning using neutral cleaners. In particular, neutral pH cleaning compositions according to the invention employ a synergistic combination of water insoluble surfactants and an anionic hydrotropes capable of forming a stable, low-foaming solution. The neutral cleaning solutions provide significant benefits over water insoluble microemulsions traditionally used for neutral cleaning compositions and provide at least equivalent cleaning efficacy as non-neutral cleaning compositions.

Environmentally acceptable dilutable hard surface treatment compositions comprising an alcohol alkoxylate is disclosed in Int'l Patent Publication No. WO2009/024745. A dilutable concentrated hard surface cleaning composition which comprises (preferably consists essentially of): a detersive nonionic surfactant based on an alcohol alkoxylate; a detersive surfactant based on glucoside surfactants; an alkanolamine; water in an amount of at least 75% wt., preferably at least about 80% wt., and optionally one or more further optional constituents, including a polyacrylate polymer, fragrances, colorants, etc. with the proviso that the compositions exclude one or more of: (a) organic acids, (b) inorganic acids, (c) organic solvents selected from glycols, glycol ethers, ether acetates, and alcohols, (d) thickeners, and (e) chelating agents based on nitrogen containing organic compounds which include a plurality of carboxylic acid groups, preferably the compositions of the invention expressly exclude two or more, preferably three or more and yet more preferably exclude four or five of (a), (b), (c), (d) and (e).

The production, recovery, and properties of xanthan gum are reviewed by F. Garcia-Ochoa et al. in Biotechnol. Adv. 2000, vol 18, pp 549 to 579. Xanthan gum is a microbial polysaccharide of great commercial significance. That reference focused on various aspects of xanthan production, including the producing organism Xanthomonas campestris, the kinetics of growth and production, the downstream recovery of the polysaccharide, and the solution properties of xanthan.

The use of polysaccharides as potential antioxidative compounds for topical administration using a lipid model system was examined by H. Trommer and R. H. Neubert in Int. J. Pharm. 2005, vol. 298, iss. 1, pp. 153 to 63. Aim of that study was the detection of polysaccharides with antioxidative properties as potential lipid protectors for topical administration. The effects of eight different polysaccharides on UV irradiation induced lipid peroxidation were investigated in a concentration dependent manner. An aqueous linolenic acid dispersion was used as an in vitro test system to examine the influences of acacia gum, agar agar, alginic acid, guar gum, novelose 330 and xanthan gum on the lipid peroxidation level after UV exposure. Four different samples of pectin and locust bean gum resulting from a swing mill grinding series were tested as well. Iron ions were added as transition metal catalysts. A UV irradiation device was used to create high level radiation. The amount of lipid peroxidation secondary products was quantified by the thiobarbituric acid assay detecting malondialdehyde. All of the tested polysaccharides showed antioxidative effects at least at one concentration. For acacia and xanthan gum, a concentration dependency of the protective effects was measured. The samples of agar agar, guar gum and novelose 330 acted antioxidatively without showing any concentration dependency. For alginic acid, prooxidative effects were determined. A correlation between grinding time and the effects of pectin and locust bean gum on the model lipid was not observed. The administration of lipid protective polysaccharides in cosmetic formulations or sunscreens could be helpful for the protection of the human skin against UV induced damage.

Rapid comparison of UVB absorption effectiveness of various sunscreens by UV-Vis spectroscopy was disclosed by J. Chou et al. in J. Anal. & Bioanal. Techn. 2017, Vol. 8, 355. Sunscreens are used to absorb or block harmful sunlight especially ultra violet (UV) radiation. An UV-vis spectrometer was employed to measure absorbance of sunscreen products. The same brand's sunscreens with sun protection factor (SPF) of 8, 15, 30, and 50 were tested under identical experimental conditions. The results show that the UV absorbance and the transmittance of the sunscreens are associated with the SPF value. The maximum absorbance of the sunscreens measured between 280 to 320 nm (UVB region) is linearly proportional to the SPF value with a correlation coefficient of 0.998 using the same brand's sunscreens. Thus, the absorbance can be used to evaluate the efficiency of a sunscreen that absorbs or blocks UVB radiation. Several commercial sunscreens of different brands but with the same SPF 30 were compared. The results confirmed that, although different brand sunscreens with the same SPF varied slightly in UV absorbance, they all offer adequate protection against UVB radiation. The utilization of UV-Vis spectroscopy is found to be particularly effective for determination of sunblock efficiency.

The effect of UV exposure on the surface chemistry of wood veneers treated with ionic liquids was disclosed by S. Partachia et al. in App. Surf Sci. 2012, vol. 258, iss. 18, pp. 6723 to 6729. The influence of four types of imidazolium-based ionic liquids (ILs) on the chemical alteration of the surface of wood veneers exposed to 254 nm UV irradiation have been studied by using image analysis, Fourier transform infrared spectroscopy and surface energy calculation. The wood treated with ionic liquids showed better stability to UV light, as demonstrated by the low lignin, carbonyl index and cellulose crystallinity index variation, as well as very small color modification of the surface with the increase of the UV exposure period, by comparing to non-treated wood. The results show that the tested ionic liquids could be effective as UV stabilizers.

Although many advances in the art of formulating a wood treatment composition have been made, protection of wood from UV radiation is a remaining challenge.

### BRIEF SUMMARY

The present invention is directed to an aqueous composition comprising an alcohol alkoxylate surfactant and xanthan gum. Under one embodiment, the weight ratio of the alcohol alkoxylate surfactant to xanthan gum is greater than 0.9:1. Under one embodiment, the aqueous composition is suitable for use in the treatment of wood surfaces.

One of the advantages of the aqueous solution is that it protects the wood surface from the damaging UV radiation.

The alcohol alkoxylate surfactant as used herein is a liquid that comprises one or more alcohol alkoxylate compounds. The alcohol alkoxylate surfactant is a non-ionic surfactant. The alcohol alkoxylate surfactant is a surfactant that comprises more than 50 wt % alcohol alkoxylate.

The alcohol alkoxylate is a compound of structure

CₙH₂ₙ₊₁—O—(CₘH₂ₘ—O)ₓ—H (I)

wherein in =6 to 18, m=2 to 4, and x=4 to 20. Suitable alcohol alkoxylates include linear alcohol alkoxylates.

The alcohol alkoxylate comprises a hydrophobic end CₙH₂ₙ₊₁—, which is a linear or a branched alkyl group, with 6 to 18 carbons. The alcohol alkoxylate also comprises a hydrophilic end that comprises several —CₘH₂ₘ—O— groups. The alkoxylate group is any group comprising an alkanediyl group —CₘH₂ₘ—, and an oxygen —O—. These alkoxylate groups are stringed together and terminated with —H.

Under one embodiment, as long as the alcohol alkoxylate behaves as a surfactant, the size and number of the —CₘH₂ₘ—O— groups is not limited. Under another embodiment, the —CₘH₂ₘ—O— group has 2, 3, 4, 5, or 6 carbons.

In the formula CₙH₂ₙ₊₁—O—(CₘH₂ₘ—O)ₓ—H, the variable x is the number of alkoxylate units in the alcohol alkoxylate. Any number of alkoxylate units may be used, as long as the alcohol alkoxylate acts as a non-ionic surfactant. The limit of the number of units depends on the length of the alkyl group CₙH₂ₙ₊₁— and on the identity of the alkanediyl group. Under one embodiment, x is between about 1 and about 30. Under one embodiment, x is between about 2 and about 20. Under one embodiment, 2≤x≤20. Under one embodiment, 6≤x≤12.

Xanthan gum is a heteropolysaccharide with a primary structure consisting of repeated pentasaccharide units. Under one embodiment, the pentasaccharide comprises D-glucose, D-mannose, D-glucuronic acid, pyruvate, and acetate units. Its main chain consists of β-D-glucose units linked at the 1 and 4 positions.

The weight ratio of the alcohol alkoxylate surfactant to xanthan gum is a key to the ability for the composition to protect a wood surface from the effects of UV radiation.

Higher ratios appear to have improved UV protection. Under one embodiment, the weight ratio of the alcohol alkoxylate surfactant to xanthan gum is greater than 0.9:1. Under one embodiment, the weight ratio of the alcohol alkoxylate surfactant to xanthan gum is greater than 5:1. Under one embodiment, the weight ratio of the alcohol alkoxylate surfactant to xanthan gum is greater than 10:1.

The present invention is also directed to an aqueous composition comprising an alcohol alkoxylate surfactant and xanthan gum, wherein the aqueous composition comprises up to about 20 wt % of alcohol alkoxylate surfactant, or about 0.01 wt % to about 10.0 wt % of alcohol alkoxylate surfactant, or about 0.01 wt % c to about 5.0 wt % of alcohol alkoxylate surfactant.

The present invention is also directed to an aqueous composition comprising an alcohol alkoxylate surfactant and xanthan gum, wherein the aqueous composition comprises up to about 8 wt % of the xanthan gum. Under one embodiment, the aqueous composition comprises between about 0.01 wt % and about 5 wt % of xanthan gum. Under one embodiment, the aqueous composition comprises between about 0.01 wt % and about 3 wt/o of xanthan gum.

In some embodiments, the compositions of the present invention further comprise water.

The aqueous composition may comprise additional ingredients or additional functional ingredients. Functional ingredients include materials that when dispersed or dissolved in the aqueous composition provides a beneficial property in a particular use. The aqueous composition may further comprise a preservative, colorant, fragrance, viscosity modifier, organic solvent, antimicrobial agent, alkalinity source, chelating agents, pH adjusters/buffers, foam modifiers, pearlising agents, stabilizing agents, rheology modifiers and combinations thereof. The optional functional ingredients may be included in the aqueous composition in an amount effective to provide the optional functional properties. An effective amount should be considered as an amount that provides the aqueous composition the optional functional property. In an aspect, the optional functional ingredient(s) are provided in the amounts of from about 0.1 wt % to about 50 wt %, preferably from about 0.1 wt % to about 20 wt %.

The present invention is also directed to a wood treatment product comprising an aqueous composition comprising an alcohol alkoxylate surfactant and xanthan gum. The wood treatment product is a product that may be manufactured, sold, and used for the purposes of treating wood, particularly wood surface. Examples of wood treatment product include wood cleaner, wood polish, floor polish, floor cleaner, furniture polish, furniture cleaner, and like.

The wood prior to treatment with the aqueous composition is bare wood, or wood that has already been exposed to some treatment, such as pressure treatment, shellacking, varnishing, and painting.

The present invention is also directed to a method of protecting a wood surface from the effects of UV radiation comprising administering an effective amount of the aqueous composition to a wood surface.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species; for example, the phrase “alcohol alkoxylate” in the singular form, may refer to a mixture of compounds each of which is also considered an alcohol alkoxylate. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

The abbreviations and symbols as used herein, unless indicated otherwise, take their ordinary meaning. The abbreviation “wt %” means percent by weight. The symbols “° C.”, “kJ”, “nm”, “cm”, “m²” “min”, “mL”, “W” mean degrees celsius, kilojoule, nanometer, centimeter, meter squared, minute, milliliters, and watt, respectively.

The term “Q.S.” means quantum satis. In the context of this disclosure, it means sufficient amount of the particular ingredient (typically, solvent or water) that the weight percent of all recited ingredients add up to 100 wt %.

When referring to chemical structures, and names, the symbols “C”, “H”, and “O” mean carbon, hydrogen, and oxygen, respectively. The symbols “-” and “=” mean single bond, and double bond, respectively. The symbols “Me”, “Et”, “Pr”, and “Bu” mean methyl, ethyl, propyl, and butyl, respectively, or CH₃—, CH₃—CH₂—, C₃Hr, and C₄H₉—, respectively. “EO” means ethylene oxide, either in the molecular form, or as a part of a larger molecule containing —CH₂—CH₂—O—.

The description of the invention uses IUPAC and common nomenclature. For example, the definition of the common nomenclature such as “alkylene”, “ethylene”, “propylene” and like, refers to “alkanediyl”, “ethanediyl”, “propanediyl” and like, or alternatively to “alkene”, “ethane”, “propene” and like.

The phrase “C9-11 alcohol” means an alcohol with 9, 10, or 11 carbons or a mixture thereof.

The abbreviations “UV”, “SPF”, “JECFA”, “FAO”, “WHO” mean “ultraviolet”, “sun protection factor”, “Joint FAO/WHO Expert Committee on Food Additives”, “Food and Agriculture Organization of the United Nations”, “World Health Organization”, respectively.

The term “about” when referring to a number means any number within a range of 10% of the number. For example, the phrase “about 0.050 wt %” refers to a number between and including 0.04500 wt % and 0.05500 wt %.

As used throughout, ranges are used as shorthand for describing each and every value that is within the range. Any value within the range can be selected as the terminus of the range.

For readability purposes, the chemical functional groups may be in their adjective form; for each of the adjective, the word “group” is assumed. For example, the adjective “alkyl” without any nouns thereafter, may be read as “an alkyl group”.

The term “mixture” is to be interpreted broadly. It refers to a mixture of ingredients. If a mixture is a liquid, a mixture may be a solution, an emulsion, a dispersion, a mixture displaying the Tyndall effect, or any other homogeneous mixture. Under one embpdment, the mixture is shelf stable. When referring to a list of ingredients, unless specifically indicated otherwise, the term “mixture” refers to a mixture of the aforementioned ingredients with each other, a mixture of any of aforementioned ingredients with other ingredients that are not aforementioned, and to a mixture of several aforementioned ingredients with other ingredients that are not aforementioned. For example, the term “mixture” in the phrase “—CₘH₂ₘ— is selected from the group consisting of ethylene, propylene, methylethylene, and mixtures thereof” refers to any of the following: a mixture of ethylene and propylene; a mixture of ethylene and methylethylene; a mixture of ethylene, propylene, and methylethylene; a mixture of ethylene and any other alkylene group; a mixture of propylene and any other alkylene group; a mixture of methethylene and any other alkylene group, a mixture of ethylene, propylene, and any other alkylene group; a mixture of ethylene, methethylene, and any other alkylene group; a mixture of propylene, methethylene, and any other alkylene group; or a mixture of ethylene, propylene, methethylene, and any other alkylene group.

Any member in a list of species that are used to exemplify or define a genus may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

All references cited herein are hereby incorporated by reference in their entireties. In the event of a conflict in a definition in the present disclosure and that of a cited reference, the present disclosure controls.

The present invention is directed to an aqueous composition comprising an alcohol alkoxylate surfactant and xanthan gum.

Under one embodiment, the weight ratio of the alcohol alkoxylate surfactant to xanthan gum is greater than 0.9:1.

Under one embodiment, the aqueous composition is suitable for use in the treatment of wood surfaces.

One of the advantages of the present invention is that it provides an aqueous solution which may be used for the treatment of wood.

One of the advantages of the aqueous solution is that it protects the wood surface from the damaging UV radiation.

The alcohol alkoxylate surfactant as used herein is a liquid that comprises one or more alcohol alkoxylate compounds. Under one embodiment, the alcohol alkoxylate surfactant consists of a single alcohol alkoxylate compound. Under one embodiment, the alcohol alkoxylate surfactant consists of a mixture of alcohol alkoxylate compounds.

The alcohol alkoxylate surfactant is a non-ionic surfactant.

The alcohol alkoxylate surfactant is a surfactant that comprises more than 50 wt % alcohol alkoxylate. The alcohol alkoxylate surfactant is sufficiently pure that it acts as a non-ionic surfactant. Under one embodiment, the surfactant contains more than 99 wt % of alcohol alkoxylate. Under one embodiment, the surfactant contains more than 95 wt % of alcohol alkoxylate. Under one embodiment, the surfactant contains more than 90 wt % of alcohol alkoxylate. Under one embodiment, the surfactant contains more than 75 wt % of alcohol alkoxylate. Under one embodiment, the surfactant contains more than 50 wt % of alcohol alkoxylate.

Examples of alcohol alkoxylate surfactant excipients (i.e., parts of surfactant that are not considered alcohol alkoxylate) include other surfactants, other non-ionic surfactants, other alcohols, other alkoxylates, solvents, organic molecules, and other compounds that are miscible with alcohol alkoxylate.

Under one embodiment, alcohol alkoxylate is a compound of structure

CₙH₂ₙ₊₁—O—(CₘH₂ₘ—O)ₓ—H (I)

wherein n=6 to 18, m=2 to 4, and x=4 to 20.

Suitable alcohol alkoxylates include linear alcohol alkoxylates. Additional alcohol alkoxylates include alkylphenol alkoxylates, branched alcohol alkoxylates, secondary alcohol alkoxylates, castor oil alkoxylates, alkylamine alkoxylates (also known as alkoxylated alkyl amines), tallow amine alkoxylates, fatty acid alkoxylates, sorbital oleate alkoxylates, end-capped alkoxylates, or combinations thereof. Further non-ionic surfactants include amides such as fatty alkanolamides, alkyldiethanolamides, coconut diethanolamide, lauramide diethanolamide, cocoamide diethanolamide, polyethylene glycol cocoamide, oleic diethanolamide, or combinations thereof.

Yet further non-ionic surfactants include polyalkoxylated aliphatic base, polyalkoxylated amide, glycol esters, glycerol esters, amine oxides, phosphate esters, alcohol phosphate, fatty triglycerides, fatty triglyceride esters, alkyl ether phosphate, alkyl esters, alkyl phenol ethoxylate phosphate esters, alkyl polysaccharides, block copolymers, alkyl polyglucocides, or combinations thereof.

Under one embodiment, the alcohol alkoxylate comprises a hydrophobic end CₙH₂ₙ₊₁—, which is a linear or a branched alkyl group, with 6 to 18 carbons. Examples of alkyl groups with 6 to 18 carbons include hexyl, heptyl, octyl, nonyl, decyl, undecyl, dodecyl, tridecyl, tetradecyl, pentadecyl, hexadecyl, heptadecyl, octadecyl, and mixtures thereof. Examples of hexyl include n-hexyl, 1-methylpentyl, 2-methylpentyl, 3-methylpentyl, 4-methylpentyl; 1,1-dimethylbutyl; 1,2-dimethylbutyl; 1,3-dimethylbutyl; 2,2-dimethylbutyl; 2,3-dimethylbutyl; 3,3-dimethylbutyl; 1-ethylbutyl; 2-ethylbutyl; 1,1,2-trimethylpropyl; 1,1,2-trimethylpropyl; 1-ethyl-1-methylpropyl; 1-ethyl-2-methylpropyl. Example of heptyl include n-heptyl, 1-methylhexyl; 2-methylhexyl; 3-methylhexyl; 4-methylhexyl; 5-methylhexyl; 1,1-dimethylpentyl; 1,2-dimethylpentyl; 1,3-dimethylpentyl; 1,4-dimethylpentyl; 2,2-dimethylpentyl; 2,3-dimethylpentyl; 2,4-dimethylpentyl; 3,3-dimethylpentyl; 3,4-dimethylpentyl; 4,4-dimethylpentyl; 1-ethylpentyl; 2-ethylpentyl; 3-ethylpentyl; 1,1,2-trimethylbutyl; 1,1,3-trimethylbutyl; 1,2,2-trimethylbutyl; 1,2,3-trimethylbutyl; 1,3,3-trimethylbutyl; 2,2,3-trimethylbutyl; 2,3,3-trimethylbutyl; 1-ethyl-1-methylbutyl; 1-ethyl-2-methylbutyl; 1-ethyl-3-methylbutyl; 2-ethyl-1-methylbutyl; 2-ethyl-2-methylbutyl; 2-ethyl-3-methylbutyl; 1-propylbutyl; 1-isopropylbutyl; 1,1,2,2-tetramethylpropyl; 1-ethyl-1,2-dimethylpropyl; 1-ethyl-2,2-dimethylpropyl; and 1,1-diethylpropyl.

Under one embodiment, the alcohol alkoxylate comprises a hydrophilic end that comprises several —CₘH₂ₘ—O— groups. The alkoxylate group is any group comprising an alkanediyl group —CₘH₂ₘ—, and an oxygen —O—. The alkanediyl group is also known as alkylene. These alkoxylate groups are stringed together and terminated with —H.

Under one embodiment, as long as the alcohol alkoxylate behaves as a surfactant, the size and number of the —CₘH₂ₘ—O— groups is not limited. Under another embodiment, the —CₘH₂ₘ—O— group has 2, 3, 4, 5, or 6 carbons.

Under one embodiment, m=2, and the —CₘH₂ₘ—O— group has 2 carbons. This group may be a —C₂H₄—O—, ethylene, or ethanediyl group.

Under one embodiment, m=3, and the —CₘH₂ₘ—O— group has 3 carbons. This group may be a —C₃H₆—O— or propylene group or propanediyl group. Further examples include —CH₂—CH₂—CH₂—, n-propylene, —CH(Me)-CH₂—, —CH₂—CH(Me)-, methylethylene, methylethanediyl, and mixtures thereof.

Under one embodiment, m=4, and the —CₘH₂ₘ—O— group has 4 carbons. This group may be a —C₄H₈—O— or butylene group or butanediyl. Further examples include —CH₂—CH₂—CH₂—CH₂—, un-butanediyl, n-butylene, —CH(Me)-CH₂—CH₂—, —CH₂—CH(Me)-CH₂—, —CH₂—CH₂—CH(Me)-, methylpropylene, methylpropanediyl, —CH(Me)₂-CH₂—, —CH(Me)-CH(Me)-, —CH₂—CH(Me)₂-, dimethylethylene, dimethylethanediyl, —CH(Et)-CH₂—, —CH₂—CH(Et)-, ethylethylene, and mixtures thereof.

For any asymmetric alkylene group, such as methylethylene, the asymmetric group has two possible orientations. For the exemplary methylethylene group in the alcohol alkoxylate of formula (I), the methylethylene group may be —CH(Me)-CH₂—, so that the alcohol alkoxylate would have a formula CₙH₂ₙ₊₁—O—CH(Me)-CH₂—O)ₓ—H, or alternatively, the methylethylene group may be —CH₂—CH(Me)-, so that the alcohol alkoxylate would have the formula Cₙ^{H}₂ₙ₊₁—O—(CH₂—CH(Me)-O)ₓ—H. Under one embodiment, the alcohol alkoxylate comprising asymmetric alkylene groups would have a mixture of orientations of the asymmetric alkylene groups.

In the formula CₙH₂ₙ₊₁₁—O—(CₘH₂ₘ—O)ₓ—H, the variable x is the number of alkoxylate units in the alcohol alkoxylate. Any number of alkoxylate units may be used, as long as the alcohol alkoxylate acts as a non-ionic surfactant. The limit of the number of units depends on the length of the alkyl group CₙH₂ₙ₊₁— and on the identity of the alkanediyl group.

Under one embodiment, x is between about 1 and about 30. Under one embodiment, x is between about 2 and about 20. Under one embodiment, 2≤x≤20. Under one embodiment, 6≤x≤12.

Under one embodiment, 2≤x≤4. Under one embodiment, 2≤x≤6. Under one embodiment, 2≤x≤8. Under one embodiment, 2≤x≤11. Under one embodiment, 2≤x≤14. Under one embodiment, 2≤x≤18. Under one embodiment, 2≤x≤24. Under one embodiment, 4≤x≤6. Under one embodiment, 4≤x≤8. Under one embodiment, 4≤x≤11. Under one embodiment, 4≤x≤14. Under one embodiment, 4≤x≤18. Under one embodiment, 4≤x≤24. Under one embodiment, 6≤x≤8. Under one embodiment, 6≤x≤11. Under one embodiment, 6≤x≤14. Under one embodiment, 6≤x≤18. Under one embodiment, 6≤x≤24. Under one embodiment, 8≤x≤11. Under one embodiment, 8≤x≤14. Under one embodiment, 8≤x≤18. Under one embodiment, 8≤x≤24. Under one embodiment, 11≤x≤14. Under one embodiment, 11≤x≤18. Under one embodiment, 11≤x≤24. Under one embodiment, 14≤x≤18. Under one embodiment, 14≤x≤24. Under one embodiment, 18≤x≤24.

The present invention is directed to an aqueous composition for UV protection of wood comprising an alcohol alkoxylate surfactant and xanthan gum. Xanthan gum is a heteropolysaccharide with a primary structure consisting of repeated pentasaccharide units. Under one embodiment, the pentasaccharide comprises D-glucose, D-mannose, D-glucuronic acid, pyruvate, and acetate units. Its main chain consists of β-D-glucose units linked at the 1 and 4 positions. The chemical structure of the main chain is identical to that of cellulose. Trisaccharide side chains contain a D-glucuronic acid unit between two D-mannose units linked at the O-3 position of every other glucose residue in the main chain. Approximately one-half of the terminal D-mannose contains a pyruvic acid residue linked via keto group to the 4 and 6 positions, with an unknown distribution. D-Mannose unit linked to the main chain contains an acetyl group at position 0-6. The presence of acetic and pyruvic acids produces an anionic polysaccharide type.

Under one embodiment, the heteropolysaccharide comprises 24 wt % to 35 wt % D-glucose, 26 wt % to 31 wt % D-mannose, 13 wt % to 18 wt % D-glucuronic acid, 1 wt % to 8 wt % pyruvate, 5 wt % to 11 wt % of acetate, and up to 25 wt % of additional units.

Further, xanthan gum may be used for its thickening aqueous solutions, stabilizing emulsions and dispersing properties. Xanthan gum is a polysaccharide with many industrial uses, including as a common food additive. It is an effective thickening agent and stabilizer to prevent ingredients from separating, usable in a variety of industries, including oil & gas, food & beverage, pharmaceutical, cosmetic, etc. Xanthan gum can be produced from simple sugars using a fermentation process and derives its name from the species of bacteria used, Xanthomonas campestris.

The xanthan gum may be obtained from any of the manufacturers or other commercial sources, including Archer Daniels Midland Company (Chicago, Ill., USA), Jungbunzlauer (Basel, Switzerland), Cargill (Minneapolis, Minn., USA), Danisco (Kobenhavn, Denmark), Fufeng Group Company Ltd. (Jinan, Shandong, People's Republic of China) and CP Kelco (Atlanta, Ga., USA), under names such as Satiaxane®, Verxan™, Grindsted®, Keltrol®, Xantural®, etc.

In some embodiments, the compositions described herein are home care compositions. In some embodiments, the home care compositions described herein can be used for cleaning, rinsing, care or treatment of industrial, domestic or communal hard surfaces, as well as textile article surfaces; they are targeted at conferring on the latter benefits such as UV protection, water repellency, soil release, stain resistance, anti-fogging, surface repair, anti-wrinkling, shine, lubrication and/or at improving the residuality, impact and or efficacy of active materials comprised in said compositions on the surfaces treated therewith. In further embodiments, the term “hard surfaces” more particularly means surfaces such as glass, windowpanes, ceramic, tiling, walls, floors, dishwares, stainless steel, hard organic polymer, or a cellulosic substrate (e.g. wood).

The present invention is also directed to an aqueous composition for UV protection of wood comprising an alcohol alkoxylate surfactant and xanthan gum, wherein the weight ratio of the alcohol alkoxylate surfactant to xanthan gum is greater than 0.9:1. The weight ratio is key to the ability for the composition to protect a wood surface from the effects of UV radiation.

Higher ratios appear to have improved UV protection. Under one embodiment, the weight ratio of the alcohol alkoxylate surfactant to xanthan gum is greater than 0.9:1. Under one embodiment, the weight ratio of the alcohol alkoxylate surfactant to xanthan gum is greater than 5:1. Under one embodiment, the weight ratio of the alcohol alkoxylate surfactant to xanthan gum is greater than 10:1.

Under one embodiment, the weight ratio of the alcohol alkoxylate surfactant to xanthan gum is between 0.9:1 and 50:1. Under one embodiment, the weight ratio of the alcohol alkoxylate surfactant to xanthan gum is between 0.9:1 and 30:1. Under one embodiment, the weight ratio of the alcohol alkoxylate surfactant to xanthan gum is between 0.9:1 and 10:1. Under one embodiment, the weight ratio of the alcohol alkoxylate surfactant to xanthan gum is between 0.9:1 and 5:1. Under one embodiment, the weight ratio of the alcohol alkoxylate surfactant to xanthan gum is between 0.9:1 and 3:1.

Under one embodiment, the weight ratio of the alcohol alkoxylate surfactant to xanthan gum is between 3:1 and 50:1. Under one embodiment, the weight ratio of the alcohol alkoxylate surfactant to xanthan gum is between 3:1 and 30:1. Under one embodiment, the weight ratio of the alcohol alkoxylate surfactant to xanthan gum is between 3:1 and 10:1. Under one embodiment, the weight ratio of the alcohol alkoxylate surfactant to xanthan gum is between 3:1 and 5:1.

Under one embodiment, the weight ratio of the alcohol alkoxylate surfactant to xanthan gum is between 5:1 and 50:1. Under one embodiment, the weight ratio of the alcohol alkoxylate surfactant to xanthan gum is between 5:1 and 30:1. Under one embodiment, the weight ratio of the alcohol alkoxylate surfactant to xanthan gum is between 5:1 and 10:1. Under one embodiment, the weight ratio of the alcohol alkoxylate surfactant to xanthan gum is between 10:1 and 50:1. Under one embodiment, the weight ratio of the alcohol alkoxylate surfactant to xanthan gum is between 10:1 and 30:1. Under one embodiment, the weight ratio of the alcohol alkoxylate surfactant to xanthan gum is between 30:1 and 50:1.

The present invention is also directed to an aqueous composition comprising an alcohol alkoxylate surfactant and xanthan gum, wherein the aqueous composition comprises up to about 20 wt % of alcohol alkoxylate surfactant.

Under one embodiment, the aqueous composition comprises between about 0.01 wt % and about 20 wt % of alcohol alkoxylate surfactant. Under one embodiment, the aqueous composition comprises between about 0.01 wt % c and about 10 wt % c of alcohol alkoxylate surfactant. Under one embodiment, the aqueous composition comprises between about 0.01 wt % and about 5 wt % of alcohol alkoxylate surfactant. Under one embodiment, the aqueous composition comprises between about 0.01 wt % and about 3 wt % of alcohol alkoxylate surfactant. Under one embodiment, the aqueous composition comprises between about 0.01 wt % and about 1.0 wt % of alcohol alkoxylate surfactant. Under one embodiment, the aqueous composition comprises between about 0.01 wt % and about 0.5 wt % of alcohol alkoxylate surfactant. Under one embodiment, the aqueous composition comprises between about 0.01 wt % and about 0.1 wt % of alcohol alkoxylate surfactant.

Under one embodiment, the aqueous composition comprises between about 0.1 wt % and about 20 wt % of alcohol alkoxylate surfactant. Under one embodiment, the aqueous composition comprises between about 0.1 wt % and about 10 wt % of alcohol alkoxylate surfactant. Under one embodiment, the aqueous composition comprises between about 0.1 wt % and about 5 wt % of alcohol alkoxylate surfactant. Under one embodiment, the aqueous composition comprises between about 0.1 wt % and about 3 wt % of alcohol alkoxylate surfactant. Under one embodiment, the aqueous composition comprises between about 0.1 wt % and about 1.0 wt % of alcohol alkoxylate surfactant. Under one embodiment, the aqueous composition comprises between about 0.1 wt % and about 0.5 wt % of alcohol alkoxylate surfactant.

Under one embodiment, the aqueous composition comprises between about 0.5 wt %/o and about 20 wt % of alcohol alkoxylate surfactant. Under one embodiment, the aqueous composition comprises between about 0.5 wt % and about 10 wt % of alcohol alkoxylate surfactant. Under one embodiment, the aqueous composition comprises between about 0.5 wt % and about 5 wt % of alcohol alkoxylate surfactant. Under one embodiment, the aqueous composition comprises between about 0.5 wt % and about 3 wt % of alcohol alkoxylate surfactant. Under one embodiment, the aqueous composition comprises between about 0.5 wt and about 1.0 wt % of alcohol alkoxylate surfactant.

Under one embodiment, the aqueous composition comprises between about 1.0 wt % and about 20 wt/o of alcohol alkoxylate surfactant. Under one embodiment, the aqueous composition comprises between about 1.0 wt % and about 10 wt % of alcohol alkoxylate surfactant. Under one embodiment, the aqueous composition comprises between about 1.0 wt % and about 5 wt % of alcohol alkoxylate surfactant. Under one embodiment, the aqueous composition comprises between about 1.0 wt % and about 3 wt % of alcohol alkoxylate surfactant.

Under one embodiment, the aqueous composition comprises between about 3 wt % and about 20 wt %/o of alcohol alkoxylate surfactant. Under one embodiment, the aqueous composition comprises between about 3 wt % and about 10 wt % of alcohol alkoxylate surfactant. Under one embodiment, the aqueous composition comprises between about 3 wt % and about 5 wt % of alcohol alkoxylate surfactant. Under one embodiment, the aqueous composition comprises between about 5 wt % and about 20 wt % of alcohol alkoxylate surfactant. Under one embodiment, the aqueous composition comprises between about 5 wt % % and about 10 wt % of alcohol alkoxylate surfactant. Under one embodiment, the aqueous composition comprises between about 10 wt % and about 20 wt % of alcohol alkoxylate surfactant.

The present invention is also directed to an aqueous composition comprising an alcohol alkoxylate surfactant and xanthan gum, wherein the aqueous composition comprises up to about 8 wt % of the xanthan gum.

Under one embodiment, the aqueous composition comprises between about 0.01 wt % and about 8 wt % of xanthan gum. Under one embodiment, the aqueous composition comprises between about 0.01 wt % and about 5 wt % of xanthan gum. Under one embodiment, the aqueous composition comprises between about 0.01 wt % and about 3 wt % of xanthan gum. Under one embodiment, the aqueous composition comprises between about 0.01 wt % and about 1 wt % of xanthan gum. Under one embodiment, the aqueous composition comprises between about 0.01 wt % and about 0.5 wt % of xanthan gum. Under one embodiment, the aqueous composition comprises between about 0.01 wt % and about 0.1 wt % of xanthan gum. Under one embodiment, the aqueous composition comprises between about 0.01 wt % and about 0.05 wt % of xanthan gum.

Under one embodiment, the aqueous composition comprises between about 0.05 wt % and about 8 wt % of xanthan gum. Under one embodiment, the aqueous composition comprises between about 0.05 wt % and about 5 wt % of xanthan gum. Under one embodiment, the aqueous composition comprises between about 0.05 wt % and about 3 wt % of xanthan gum. Under one embodiment, the aqueous composition comprises between about 0.05 wt % and about 1 wt % of xanthan gum. Under one embodiment, the aqueous composition comprises between about 0.05 wt % and about 0.5 wt % of xanthan gum. Under one embodiment, the aqueous composition comprises between about 0.05 wt % and about 0.1 wt % of xanthan gum.

Under one embodiment, the aqueous composition comprises between about 0.1 wt % and about 8 wt % of xanthan gum. Under one embodiment, the aqueous composition comprises between about 0.1 wt % and about 5 wt % of xanthan gum. Under one embodiment, the aqueous composition comprises between about 0.1 wt % and about 3 wt % of xanthan gum. Under one embodiment, the aqueous composition comprises between about 0.1 wt % and about 1 wt % of xanthan gum. Under one embodiment, the aqueous composition comprises between about 0.1 wt % and about 0.5 wt % of xanthan gum.

Under one embodiment, the aqueous composition comprises between about 0.5 wt % and about 8 wt % of xanthan gum. Under one embodiment, the aqueous composition comprises between about 0.5 wt % and about 5 wt % of xanthan gum. Under one embodiment, the aqueous composition comprises between about 0.5 wt % and about 3 wt % of xanthan gum. Under one embodiment, the aqueous composition comprises between about 0.5 wt % and about 1 wt % of xanthan gum.

Under one embodiment, the aqueous composition comprises between about 1 wt % and about 8 wt % of xanthan gum. Under one embodiment, the aqueous composition comprises between about 1 wt % and about 5 wt % of xanthan gum. Under one embodiment, the aqueous composition comprises between about 1 wt % and about 3 wt % of xanthan gum. Under one embodiment, the aqueous composition comprises between about 3 wt % and about 8 wt % of xanthan gum. Under one embodiment, the aqueous composition comprises between about 3 wt % and about 5 wt % of xanthan gum. Under one embodiment, the aqueous composition comprises between about 5 wt % and about 8 wt % of xanthan gum.

The composition of the present invention further comprises water. Water may be distilled or deionized.

According to one embodiment of the invention, the aqueous composition may comprise additional ingredients. The compositions may include additional components or agents, referred to herein as additional functional ingredients. Functional ingredients include materials that when dispersed or dissolved in the aqueous composition provides a beneficial property in a particular use.

Under one embodiment, the aqueous composition may further comprise a preservative, colorant, fragrance, viscosity modifier, organic solvent, antimicrobial agent, alkalinity source, chelating agents, pH adjusters/buffers, foam modifiers, pearlising agents, stabilizing agents, rheology modifiers and combinations thereof.

Under one embodiment, no additional functional ingredients are added to the neutral cleaning composition. For example, no UV protection agent is added as a result of the UV protection ability of the aqueous composition. As a further example, no viscosity modifier or rheology modifier is included due to the presence of xanthan gum. In a still further embodiment of the invention, no builder, chelant, sequestrant and/or threshold agent or inhibitor is included. Still further, in another embodiment, the aqueous composition does not contain an organic solvent.

The optional functional ingredients may be included in the aqueous composition in an amount effective to provide the optional functional properties. An effective amount should be considered as an amount that provides the aqueous composition the optional functional property. In an aspect the optional functional ingredient(s) are provided in the amounts of from about 0.1 wt % to about 50 wt %, preferably from about 0.1 wt % to about 20 wt %.

The present invention is also directed to a wood treatment product comprising an aqueous composition comprising an alcohol alkoxylate surfactant and xanthan gum, wherein the weight ratio of the alcohol alkoxylate surfactant to xanthan gum is greater than 0.9:1.

In some embodiments, the compositions described herein are provided in the form of a coating suitable for use on an indoor or outdoor surface. In some embodiments, the compositions described herein are in a form selected from: a varnish; a paint; and a stain.

In some embodiments, the wood treatment product is a product that may be manufactured, sold, and used for the purposes of treating wood, particularly a wood surface.

Under one embodiment, the wood prior to treatment with the aqueous composition is bare wood, meaning a wood that has not been treated with any other liquid since the wood surface has been formed by a saw, an axe, a lathe, a sander, a sandpaper, a router, a planer, a drill, or any other woodworking hand tools or power tools.

Under one embodiment, the wood prior to treatment with the aqueous composition is treated wood, meaning a wood that has been exposed to another liquid prior to the treatment with the aqueous composition of the present invention. Such treatment may include pressure treatment, shellacking, varnishing, painting, and like.

The phrase “wood treatment product” should be interpreted broadly. Examples of wood treatment product include wood cleaner, wood polish, floor polish, floor cleaner, furniture polish, furniture cleaner, and like.

Wood that is suitable for treatment by the aqueous composition comprise heartwood, sapwood, earlywood, latewood, timber, lumber, monocot wood, and like. The wood many be dimensional wood, plywood, oriented strand board, particle board, and like.

The wood may be soft wood or hard wood. The wood may be coniferous or deciduous. Examples of suitable wood includes pine, spruce, larch, juniper, aspen, hornbeam, birch, alder, fir, beech, oak, elm, cheery, pear, maple, linden, ash, poplar, walnut, and like.

The present invention is also directed to a method of protecting a wood surface from the effects of UV radiation comprising administering an effective amount of the aqueous composition to a wood surface. In some embodiments, the administration may be done with a paint brush, a roller, a spray, or any other painting tool.

An effective amount should be considered as an amount that provides the wood with a partial or full protection against UV radiation.

### EXAMPLES

Experiments used to elucidate the formulation range of cleaning composition comprising xanthan gum and alcohol ethoxylate show surprising and unexpected synergistic effects. The experiments below are not necessarily presented in the chronological order.

### Example 1

To test the efficiency of UV protection, the transmittance of UV-Vis light through a solution of several different xanthan gums was conducted. Solutions of 0.1%, 0.2%, 0.3%, 0.4% and 0.5% of each of Kalzan AP-AS, NovaXan 80T, and NovaXan 40/OptiXan 40 were prepared. Kelzan™ AP-AS is an industrial grade of xanthan gum for use in transparent acidic systems, available from CP Kelko (Atlanta, Ga., USA).

NovaXan™ 80T is an 80 mesh particle size grade xanthan gum with superior solution transparency. It is a cream colored, free-flowing powder that meets the specifications of the National Formulary, the Food Chemicals Codex and the JECFA. This product is formulated to produce solutions with a high degree of clarity and transparency, and is available from Archer Daniels Midland Company (Chicago, Ill., USA).

NovaXan™ 40 is xanthan gum, that is an off-white to light tan colored, free-flowing granular powder that meets the specifications of the National Formulary, the Food Chemicals Codex and the JECFA. This product exhibits reduced dusting and easier handling characteristics when compared to finer mesh xanthan gum products, and is available from Archer Daniels Midland Company (Chicago, Ill., USA).

OptiXan™ 40 is an emulsifier and thickener xanthan gum in the form of a cream to tan colored, free-flowing powder or granules with a characteristic odor, and a mesh size of 40. This product is intended for use in non-food applications as thickener and rheology control agent, such as in paints, printing inks, and coatings, and is available from Archer Daniels Midland Company (Chicago, Ill., USA).

UV-vis spectra were obtained at a wavelength of 200-400 nm, 5 nm data interval, ordinate mode A, at a scan speed of 923.59 nm/min, 1 cycle (detector PMT: Gain-Auto; response 0.2 s, slits PMT: fixed 2 nm, CBM: Fixed 100%).

An absorbance signal (either as a peak or as a shoulder) in the region of 252-256 nm was observed at the recited concentrations for the three xanthan gum compositions, as presented in Table 1.

TABLE 1
Intensity of signal at 252-256 nm

| Concentration | Kelzan AP-AS | NovaXan 80T | NovaXan 40/OptiXan 40 |
|---|---|---|---|
| 0 wt % | 0.19 | 0.17 | 0.18 |
| 0.1 wt % | 0.29 | 0.29 | 0.94 |
| 0.2 wt % | 0.39 | 0.53 | 1.61 |
| 0.3 wt % | 0.48 | 0.76 | 2.21 |
| 0.4 wt % | 0.57 | 0.99 | 2.72 |
| 0.5 wt % | 0.69 | 1.36 | 3.09 |

As it can be seen, Kelzan AP-AS shows little absorbance, while NovaXan 80T starts showing an effect in this range, and NovaXan 40/Optixan 40 shows high absorbance. Due to these results, it can be hypothesized that NovaXan 40/Optixan 40 material provides a good level of protection in the UV spectrum.

### Example 2

To test the UV effects on wood treated with model formulations, a wood sample treated with model formulations and exposed to a light approximating intense sunlight.

Four model formulations of wood care product were prepared. The model formulations comprised selected components of wood care product, but did not contain color or fragrance. The four model formulations were prepared as shown in Table 2.

TABLE 2

| Component | Form. 1 | Form. 2 | Form. 3 | Form. 4 |
|---|---|---|---|---|
| C9-1I alcohol EO 7.5-8:1 | 2 wt % | 2 wt % | 2 wt % | 2 wt % |
| Glutaraldehyde—50% soln. | 1 wt % | 1 wt % | 1 wt % | 1 wt % |
| NovaXan 40/Optixan 40 | 0 wt % | 0.25 wt % | 0.45 wt % | 0.85 t % |

Samples of the model formulations 1, 2, 3, and 4, and similar amount of deionized water were brushed in uniform amounts of approximately 8 cm×8 cm×50 μm film to a surface of a wood sample. An area of the wood sample was also left untreated. The wood sample is of species that is typically used in the construction of wood floors. The surface was uniform with tight grain, free of knots, approximately 10 cm×80 cm in size, and was bare prior to the application of the model formulations and water.

To test UV effects on wood, the Q-SUN Xenon Test Chamber (Model: Xe-3-HS) was used. The Q-SUN Xe-3 xenon arc chamber reproduces the damage caused by full-spectrum sunlight and rain. In a few days or weeks, the Q-SUN tester can reproduce the damage that occurs over months or years outdoors.

The treated sample of wood was placed into the test chamber. Half of the treated surface of the wood sample, lengthwise, was covered to prevent exposure. The treated wood sample was exposed at 0.35 W/m² at 340 nm, at a temperature of 63° C., for 116 hours. The lamp delivered approximately 150 kJ/m² to the treated sample of wood, or about the equivalent of 22 days of sun in Miami or 44 days of sun in Mexico City.

The untreated areas of wood that was exposed were noticeably darker than the unexposed wood. There was no difference between the area of the wood sample treated with deionized water and untreated wood. This confirms the notion that water has no effect on UV protection.

There is no perceptible difference between the unexposed areas treated with water or model formulations 1 to 4 and the unexposed untreated areas. This observation indicates that the model formulations do not affect the color of the bare wood. Further, this observation indicates that the model formulations do not darken the bare wood. Further, this observation indicates that the model formulations do not lighten or bleach the bare wood.

There was no noticeable difference between the area treated with model formulation 1 and that of the untreated area. The areas that were treated with model formulations 2, 3, and 4, show a progressive decrease of darkening of the area, compared to the darkened untreated area. However, all of the areas treated with the formulations show some darkening compared to the unexposed area.

From this study it can be concluded that NovaXan 40/OptiXan 40 provides a good level of protection to wood at the conditions tested.

### Example 3

Formulations of proposed BDC for wood and laminate flooring were prepared as presented in Table 3.

TABLE 3

| Name | Function | Formulation 5 | Fomtulation 6 |
|---|---|---|---|
| C9-11 alcohol | surfactant | 1.00 | 1.00 |
| EO 7.5-8 | | | |
| Xanthan gum | thickener | 0.25 | 0.25 |
| Bright yellow | color | 0.00462 | 0.00462 |
| Red ST | color | 0.00153 | 0.00153 |
| Glutaraldehyde | preservative | 0.10 | 0.10 |
| sol. 50% | | | |
| Tinogard TL 44 | color preservative | 0.012 | 0 |
| Water | solvent | Q.S. (~98.6) | Q.S. (~98.6) |

Formulations 5 and 6 have a similar composition, except that the latter contains Tinogard TL 44. Tinogard® TL is a broadband UV absorber for stabilization of transparent packaged products. Tinogard TL protects colors, fragrances, natural compounds and other sensitive ingredients from photolytic and/or photooxidative degeneration, thus providing long-lasting shelf life even with light-sensitive formulations. Tinogard TL comprises or consists of benzotriazolyl dodecyl p-cresol or 2-(2H-benzotriazol-2-yl)-6-dodecyl-4-methyl-phenol.

Samples of the formulations 5 and 6 were brushed in uniform amounts onto a surface of a wood sample. The treated sample of wood was placed into the test chamber, and was exposed at 0.35 W/m² at 340 nm, at a temperature of 63° C., for 60 hours. At 45 hours of exposure the effect was already visible.

The wood that has been treated with formulation 5 or 6 shows UV protection, in that the wood surface did not darken as areas that were not treated or that were treated with water. Further, there is no observable difference between the areas that were treated with formulation 5 and those treated with Formulation 6.

From this experiment, it can be concluded that both product formulation with and without UV absorber for stabilization of colors in solutions show UV protection in bare wood, and that the presence or absence of such UV absorbers has no observable effect on the UV protection of the wood.

### Example 4

UV protection effect of model formulations containing Neodol and xanthan gum was investigated. A full factorial design containing two levels (0.15 wt % and 0.45 wt %) of two levels of NovaXan (NovaXan 40 and NovaXan 80T) with 5 levels of Neodol 91-8 (0.1, 0.5, 1, 1.5, and 2 wt %) was designed, with formulations numbered 11 through 30. Formulation 11 to 15 comprise 0.15 wt % NovaXan 40 and 0.1, 0.5, 1.0, 1.5, or 2.0 of Neodol; formulations 16 to 20 comprise 0.45 wt % NovaXan 40 and 0.1, 0.5, 1.0, 1.5, or 2.0 of Neodol; formulations 21 to 25 comprise 0.15 wt % NovaXan 80T and 0.1, 0.5, 1.0, 1.5, or 2.0 of Neodol; and formulations 26 to 30 comprise 0.45 wt % NovaXan 80T and 0.1, 0.5, 1.0, 1.5, or 2.0 of Neodol. Additional formulations 31 to 38 comprise 0.45 wt % NovaXan 40 only; 0.45 wt % NovaXan 80T only; 100% Neodol 91-8; a mixture of 0.45 wt % NovaXan 40 in Neodol; a mixture of 0.45 wt % NovaXan 80T in Neodol; 100 wt % water; and a blank, respectively.

Neodol is a C9-11 alcohol ethoxylate with eight ethylene oxide groups.

A piece of wood treated samples 1 to 28 was exposed at 0.35 W/m² at 340 nm, at a temperature of 63° C., for 68 hours. At 45 hours the effect was already visible, but the study finished at 68 hours of exposure, the effect is significantly visible. A gradient can be perceived according to the increasing concentration of Neodol. At 68 hours no visible effect is still perceivable of neither gum NovaXan 40 or NovaXan 80T (samples 21 and 22). Also, Neodol is seen to have no clearance effect on its own at 100% concentration (sample 23). In other experiments, both xanthan gums alone showed a difference up until 116 hours, but for this case, at 68 hours the effect is very clear and a clear improvement in protection is perceived in the circles.

From this study, it can be concluded that NovaXan 40 and NovaXan 80T show slight UV protection but when either of them is combined with Neodol 91-8, the effect is increased. Further, less time is required to perceive the UV protection.

### Example 5

To obtain an understanding between the interactions of alcohol ethoxylate, UV absorber, and xanthan gum, a partial factorial experiment was designed. Each of these ingredients was investigated at three different levels. The alcohol ethoxylate Neodol 91-8 (a C9-11 alcohol ethoxylate with eight ethylene oxide groups) was investigated at 0.00 wt %, 1.50 wt %, and 3.00 wt %. The UV absorber Tinogard TL (benzotriazolyl dodecyl p-cresol) was investigated at 0.00 wt %, 0.012 wt %, and 0.024 wt %. The xanthan gum was investigated at 0.00 wt %, 0.46 wt %, and 0.92 wt %. The formulation is presented in Table 4 below. The balance of the formulation was water.

TABLE 4
Partial Factorial Design for Investigating an Interaction
between Alcohol Ethoxylate, UV Absorber and Xanthan Gum

| | alcohol ethoxylate | UV absorber | |
|---|---|---|---|
| Formulations | Neodol 91-8 | Tinogard TL | xanthan gum |
| 41 | 0.00 wt % | 0.017 wt % | 0.00 wt % |
| 42 | 0.00 wt % | 0.024 wt % | 0.92 wt % |
| 43 | 1.50 wt % | 0.024 wt % | 0.92 wt % |
| 44 | 1.50 wt % | 0,012 wt % | 0.46 wt % |
| 45 | 3.00 wt % | 0,024 wt % | 0.46 wt % |
| 46 | 0.00 wt % | 0.00 wt % | 0.92 wt % |
| 47 | 3.00 wt % | 0.00 wt % | 0.92 wt % |
| 48 | 0.00 wt % | 0.024 wt % | 0.00 wt % |
| 49 | 3.00 wt % | 0.024 wt % | 0.00 wt % |
| 50 | 3.00 wt % | 0,012 wt % | 0.92 wt % |
| 51 | 3.00 wt % | 0.00 wt % | 0.00 wt % |
| 52 | 0.00 wt % | 0.00 wt % | 0.46 wt % |
| 53 | 1.50 wt % | 0,00 wt % | 0.0 t % |

Approximately 0.5 mL samples of each of the formulations 41 to 53 above, plus water (formulation 54) was brushed to a pine wood surface and was left to dry at ambient temperature. The wood also had an area that was left untreated (designated as “formulation 55”).

The treated wood was placed into the test chamber described in Experiment 2, and was exposed at 0.35 W/m² at 340 nm, at a temperature of 63° C., for 20 hours.

After the exposure, the color of the treated area was ascertained by the use of Spectro-guide 45/0 Gloss Color Spectrometer (Model 6801, available from BYK-Gardner GmbH, Geretsried, Germany). Each of the areas was sampled five times and averaged.

The color spectrometer obtained data under the CIELAB color space. The CIELAB color space (also known as CIE L*a*b* or sometimes abbreviated as simply “Lab” color space) is a color space defined by the International Commission on Illumination (CIE) in 1976. It expresses color as three values: L* for the lightness from black (0) to white (100), a* from green (−) to red (+), and b* from blue (−) to yellow (+). CIELAB was designed so that the same amount of numerical change in these values corresponds to roughly the same amount of visually perceived change. The change of color is given by the equation:

ΔE=[(L*₂−L*₁)²+(a*₂−a*₁)²+(b*₂−b*₁)²]^{1/2}.

For values of ΔE<0.2, the changes are considered invisible. For values 0.2<ΔE<2, there is a small color change. For values 2<ΔE<3, the color change is visible by a high quality filter. For values 3<ΔE<6, the color change is visible by a medium quality filter. For values 6<ΔE<12, there is a distinct color change. For values ΔE>12, it is a different color.

The treated wood surface was exposed for an additional 20 hours (for a total of 40 hours), and after the exposure the color measurements was sampled in quintuplicate.

The entire process consisting of the treatment of the wood surface, 20-hour exposure, color measurements, additional 20-hour exposure, and color measurements, was repeated in the same manner once. The color data for both runs are presented in Tables 5 and 6 below. Table 5 shows initial data, and data after 20 hours, and in column ΔE the difference between the initial color and the color after 20 hours. Table 6 shows data after 40 hours, and in column ΔE the difference between the initial color and the color after 40 hours. For Table 6, the initial values of L*, a* and b* are the same as listed in Table 5.

TABLE 5
Determination of color change after 20 hours

| | Initial | | | After 20 hours | | | | |
|---|---|---|---|---|---|---|---|---|
| Form. | L* | a* | b* | L* | a* | b* | ΔL* | ΔE |
| 41 | 86.45 | 3.47 | 17.45 | 80.62 | 5.7 | 25.37 | −5.83 | 10.08 |
| 41 | 82.14 | 5.18 | 20.45 | 79.51 | 4.7 | 24.64 | −2.63 | 4.97 |
| 42 | 83.6 | 4.36 | 18.73 | 83.48 | 5.87 | 19.39 | −0.12 | 1.65 |
| 42 | 83.99 | 4.29 | 18.6 | 82.16 | 6.99 | 19.55 | −1.83 | 3.4 |
| 43 | 84.47 | 4.13 | 18.57 | 84.04 | 3.54 | 22.43 | −0.43 | 3.93 |
| 43 | 84.17 | 4.2 | 18.4 | 82.25 | 5.06 | 25.58 | −1.92 | 7.48 |
| 44 | 80.81 | 5.71 | 22.5 | 81.88 | 5.41 | 25.62 | 1.07 | 3.31 |
| 44 | 85.3 | 3.87 | 18.42 | 81.41 | 6.34 | 21.14 | −3.89 | 5.35 |
| 45 | 82.93 | 4.69 | 19.55 | 83.67 | 3.78 | 22.01 | 0.74 | 2.73 |
| 45 | 85.11 | 3.96 | 17.7 | 84.18 | 3.17 | 25.88 | −0.93 | 8.27 |
| 46 | 84.63 | 4.14 | 18.28 | 82.21 | 3.91 | 25.09 | −2.42 | 7.23 |
| 46 | 86.35 | 3.51 | 16.96 | 82.07 | 6.42 | 19.63 | −4.28 | 5.82 |
| 47 | 85.14 | 3.82 | 17.87 | 84.95 | 3.25 | 23.85 | −0.19 | 6.01 |
| 47 | 83.59 | 4.57 | 19.04 | 82.06 | 5.02 | 24.87 | −1.53 | 6.04 |
| 48 | 81.76 | 5.42 | 21.19 | 83.21 | 4.4 | 25.19 | 1.45 | 4.38 |
| 48 | 83.38 | 4.54 | 19.18 | 83.73 | 4.98 | 20.96 | 0.35 | 1.87 |
| 49 | 84.45 | 4.29 | 18.37 | 83.61 | 6.06 | 19.49 | −0.84 | 2.26 |
| 49 | 86.12 | 3.59 | 17.46 | 79.73 | 8.89 | 21.04 | −6.39 | 9.04 |
| 50 | 84.02 | 4.27 | 18.24 | 82.61 | 4.44 | 22.5 | −1.41 | 4.49 |
| 50 | 83.56 | 4.65 | 19.96 | 83.22 | 5.44 | 21.41 | −0.34 | 1.69 |
| 51 | 85.25 | 3.98 | 18.08 | 59.17 | 3.06 | 15.95 | −26.08 | 26.18 |
| 51 | 86.51 | 3.36 | 17.13 | 83.67 | 3.93 | 22.09 | −2.84 | 5.74 |
| 52 | 85.95 | 3.58 | 17.68 | 82.62 | 5.43 | 21.66 | −3.33 | 5.51 |
| 52 | 86.22 | 3.53 | 17.15 | 81.97 | 6.59 | 19.3 | −4.25 | 5.66 |
| 53 | 84.02 | 4.26 | 18.39 | 80.45 | 6.23 | 26.16 | −3.57 | 8.77 |
| 53 | 86.23 | 3.53 | 17.55 | 81.54 | 5.23 | 25.01 | −4.69 | 8.97 |
| 54 | 85.44 | 3.89 | 18.13 | 81.52 | 4.84 | 25.72 | −0.30 | 8.6 |
| 55 | 81.5 | 5.34 | 22.51 | 81.8 | 4.28 | 24.93 | −3.92 | 2.66 |

TABLE 6
Determinationof color change after 40 hours

| | After 40 hours | | | | |
|---|---|---|---|---|---|
| Form. | L* | a* | b* | ΔL* | ΔE |
| 41 | 80.47 | 6.03 | 28.59 | -5.98 | 12.9 |
| 41 | 79.32 | 6.61 | 30.01 | -2.82 | 10.07 |
| 42 | 80.71 | 8.97 | 20.63 | -2.89 | 5.76 |
| 42 | 80.58 | 8.51 | 20.81 | -3.41 | 5.86 |
| 43 | 79.24 | 10.6 | 20.03 | -5.23 | 8.45 |
| 43 | 78.04 | 7.02 | 32.31 | -6.13 | 15.46 |
| 44 | 78.49 | 7.12 | 31.1 | -2.32 | 9.02 |
| 44 | 78.46 | 10.57 | 20.54 | -6.84 | 9.81 |
| 45 | 82.02 | 5.02 | 24.55 | -0.91 | 5.09 |
| 45 | 81.43 | 4.75 | 30 54 | -3.68 | 13.38 |
| 46 | 78.56 | 5.85 | 30.98 | -6.07 | 14.18 |
| 46 | 79.38 | 9.16 | 20.93 | -6.97 | 9.81 |
| 47 | 82.66 | 5.58 | 23.31 | -2.48 | 6.23 |
| 47 | 78.36 | 6.87 | 30.18 | -5.23 | 12.52 |
| 48 | 81.22 | 5.67 | 27.97 | -0.54 | 6.81 |
| 48 | 81.31 | 7.01 | 23 53 | -2.07 | 5.41 |
| 49 | 80.16 | 9.34 | 22.04 | -4.29 | 7.57 |
| 49 | 77.65 | 11.73 | 20.52 | -8.47 | 12.14 |
| 50 | 79.5 | 6.51 | 26.2 | -4.52 | 9.42 |
| 50 | 78.32 | 6.19 | 29.93 | -3.24 | 11.37 |
| 51 | 78.76 | 5.41 | 30.45 | -6.49 | 14.04 |
| 51 | 81.44 | 5.24 | 24.31 | -5.07 | 8.99 |
| 52 | 80.77 | 7.03 | 23.5 | -5.18 | 8.52 |
| 52 | 77.74 | 9.52 | 26.28 | -8.48 | 13.83 |
| 53 | 77.6 | 7.41 | 32.01 | -6.42 | 15.38 |
| 53 | 78.96 | 6.52 | 30.19 | -7.27 | 14.88 |
| 54 | 77.41 | 7.34 | 30.65 | -8.03 | 15.27 |
| 55 | 81.67 | 5.3 | 27.22 | 0.17 | 4.71 |

An analysis of the above data included Pareto charts of the standardized effects. Table 7 lists the standardized effects of the concentrations of alcohol ethoxylate, UV absorber, xanthan gum, and selected cross-factors for ΔL*, at α=0.15, for data after 20 hours and 40 hours of exposure. Table 8 lists the standardized effects of the concentrations of alcohol ethoxylate, UV absorber, xanthan gum, and selected cross-factors for ΔE, at α=0.15, for data after 20 hours and 40 hours of exposure.

TABLE 7
Standardized effects of selected factors on the ΔL*

| Factor | Exposure: 20 hrs | Exposure: 40 hrs |
|---|---|---|
| UV absorber | 2.72 | 2.29 |
| alcohol ethoxylate × xanthan gum | 2.53 | 1.71 |
| xanthan gum | 2.19 | 0.20 |
| alcohol ethoxyl ate | 1.10 | 0.13 |

TABLE 8
Standardized effects of selected factors on the ΔE

| Factor | Exposure: 20 hrs | Exposure: 40 hrs |
|---|---|---|
| alcohol ethoxylate | — | 5.79 |
| UV absorber | 2.72 | 2.02 |
| xanthan gum | 1.70 | 0.74 |
| alcohol ethoxylate × alcohol | — | 4.09 |
| ethoxylate | | |
| alcohol ethoxylate × UV absorber | — | 5.89 |
| alcohol ethoxylate × xanthan gum | — | 3.79 |
| UV absorber × xanthan gum | 1.48 | |
| xanthan gum × xanthan gum | — | 2.92 |

### Example 6

Twenty-eight model formulations of various alcohol ethoxylate and xanthan gum were prepared as presented in Table 9. Formulations wherein entries for both alcohol ethoxylate and xanthan gum are “0.00 wt %” means that the formulation applied is deionized water. Formulations wherein entries for both alcohol ethoxylate and xanthan gum are “--” means that no treatment was applied. The column labeled “alcohol ethoxylate:xanthan gum ratio” is calculated ratio of alcohol ethoxylate to xanthan gum in wt %; entries “-” mean that the formulation did not contain both alcohol ethoxylate and xanthan gum.

The twenty-eight formulations were applied to a wood surface in a similar manner as that discussed in previous examples. The treated wood was placed into the test chamber described in Experiment 2, and was exposed at 0.35 W/m² at 340 nm, at a temperature of 63° C., for 116 hours.

The wood surface that was left untreated, such as those of “formulations” 74 and 79, showed darkening of the wood surface. UV protection was judged based on the darkness of the wood compared to that of untreated surface: the lightest was judged to be “Excellent”, the slightly darker was judged to be “Good”, more darker was “Fair”, and the darkest was “Poor”.

TABLE 9

| | alcohol | xanthan | alcohol ethoxylate: | |
|---|---|---|---|---|
| Form. | ethoxylate | gum | xanthan gum ratio | UV Protection |
| 61 | 0.00 wt % | 0.00 wt % | — | Poor |
| 62 | 1.50 wt % | 0.00 wt % | — | Fair |
| 63 | 0.00 wt % | 0.45 wt % | — | Poor |
| 64 | 5.00 wt % | 0.45 wt % | 11:1 | Excellent |
| 65 | 0.10 wt % | 0.00 wt % | — | Poor |
| 66 | 0.10 wt % | 0.00 wt % | — | Poor |
| 67 | 2.00 wt % | 0.45 wt % | 4.4:1 | Good |
| 68 | 0.00 wt % | 0.00 wt % | — | Poor |
| 69 | 0.10 wt % | 0.45 wt % | 0.22:1 | Poor |
| 70 | 10.0 wt % | 0.45 wt % | 22.2:1 | Excellent |
| 71 | 0.50 wt % | 0.45 wt % | 1.1:1 | Fair |
| 72 | 7.00 wt % | 0.45 wt % | 4.4:1 | Good |
| 73 | 0.00 wt % | 0.00 wt % | — | Poor |
| 74 | — | — | — | Poor |
| 75 | 1.50 wt % | 0.23 wt % | 6.5:1 | Good |
| 76 | 0.50 wt % | 0.45 wt % | 1.1:1 | Fair |
| 77 | 2.00 wt % | 0.00 wt % | — | Poor |
| 78 | 0.00 wt % | 0.00 wt % | — | Poor |
| 79 | — | — | — | Poor |
| 80 | 0.10 wt % | 0.45 wt % | 0.22:1 | Poor |
| 81 | 1.50 wt % | 0.00 wt % | — | Poor |
| 82 | 0.00 wt % | 0.45 wt % | — | Poor |
| 83 | 2.00 wt % | 0.00 wt % | — | Fair |
| 84 | 1.50 wt % | 0.23 wt % | 6.5:1 | Good |
| 85 | 10.00 wt % | 0.45 wt % | 22.2:1 | Excellent |
| 86 | 500 wt % | 0.45 wt % | 11.1:1 | Excellent |
| 87 | 0.00 wt % | 0.23 wt % | — | Poor |
| 88 | 0.00 wt % | 0.23 wt % | — | Poor |

The observed data between the duplicative formulations suggest that the data is reproducible and consistent. The data shows that there is a synergy between alcohol ethoxylate and xanthan gum. The use of formulations comprising alcohol ethoxylate without xanthan gum appears to have no or limited UV protection (see, for example, formulations 62, 65, 66, 77, 81, or 83). Likewise, the use of formulations comprising xanthan gum without alcohol ethoxylate also appears to have no or limited UV protection (see, for example, formulations 63, 82, 87, and 88). Formulations that result in UV protection contain both alcohol ethoxylate and xanthan gum.

It thus appears that the high ratio of alcohol ethoxylate to xanthan gum is crucial to UV protection.

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

1. A home care composition comprising an alcohol alkoxylate surfactant and a polysaccharide gum, wherein the weight ratio of the alcohol alkoxylate surfactant to the polysaccharide gum is greater than 0.9:1.

2. The home care composition according to claim 1, wherein the polysaccharide gum is a nonionic polysaccharide gum.

3. The home care composition according to claim 1, wherein the polysaccharide gum is selected from: xanthan gum; guar gum; locust bean gum; dammar gum; and tara gum.

4. The home care composition according to claim 1, wherein the polysaccharide gum comprises xanthan gum.

5. The home care composition according to claim 1, wherein the alcohol alkoxylate surfactant comprises an alcohol alkoxylate of the formula (I):
CₙH₂ₙ₊₁—O—(CₘH₂ₘ—O)ₓ—H (I)
wherein n=6 to 18, m=2 to 4, and x=4 to 20.

6. The home care composition according to claim 5, wherein —CₘH₂ₘ— is selected from the group consisting of —CH₂—CH₂—, ethylene, —CH₂—CH₂—CH₂—, n-propylene, —CH(Me)-CH₂—, —CH₂—CH(Me)-, methylethylene, and mixtures thereof.

7. The home care composition according to claim 5, wherein —CₘH₂ₘ— is —CH₂—CH₂— or ethylene.

8. The home care composition according to claim 5, wherein CₙH₂ₙ₊₁— is a linear alkyl group.

9. The home care composition according to claim 5, wherein n=8 to 13.

10. The home care composition according to claim 5, wherein n=9 to 11.

11. (canceled)

12. The home care composition according to claim 1, wherein the weight ratio of the alcohol alkoxylate surfactant to the polysaccharide gum is greater than 3:1.

13. (canceled)

14. (canceled)

15. The home care composition according to claim 1, comprising from about 0.01 wt. % to about 10.0 wt. % of alcohol alkoxylate surfactant.

16. (canceled)

17. (canceled)

18. The home care composition according to claim 1, comprising from about 0.01 wt. % to about 5.0 wt. % of the polysaccharide gum.

19. (canceled)

20. The home care composition according to claim 1, wherein the combined concentration of alcohol alkoxylate surfactant and polysaccharide gum is greater than about 0.1 wt. %.

21. The home care composition according to claim 1, wherein the composition provides UV protection for a wooden surface.

22. The home care composition according to claim 1, wherein the composition is configured to reduce color fading of from a wooden surface.

23. The home care composition according to claim 1, wherein the composition is provided in the form of a coating suitable for use on an indoor or outdoor surface.

24. The home care composition according to claim 23, wherein the coating is in a form selected from: a varnish; a paint; and a stain.

25. A method of protecting a wooden surface from UV radiation comprising applying an effective amount of the home care composition according to claim 1 to a wooden surface in need thereof.

26. A method for modifying the porosity of a wooden surface comprising applying an effective amount of the home care composition according to claim 1 to a wooden surface in need thereof.

27. (canceled)

28. (canceled)

29. (canceled)

30. (canceled)

31. (canceled)

32. (canceled)

33. (canceled)

34. (canceled)
